(19) United States
(12) Patent Application Publication
(10) Pub. No.: US 2007/0206393 A1
(43) Pub. Date: Sep. 6, 2007

(54) SOLAR POWERED DECORATIVE PRODUCT

(76) Inventor: Wai Kiat Michael Soon, Calgary (CA)

Correspondence Address: KEN BURRASTON;KIRTON & MCCONKIE, PO BOX 45120, SALT LAKE CITY, UT, 84145-0120, US

(21) Appl. No.: 11/308,080

(22) Filed: Mar. 6, 2006

(51) Int. Cl. H01R 33/00; F21L 4/00; F21V 21/32; F21W 121/00

(52) U.S. Cl. 362/653; 362/183; 362/239; 362/806

(57) ABSTRACT

In some embodiments of the invention, a solar powered decorative product can include a base having a plurality of connectors. A plurality of decorative structures can attach to and be detached from the connectors. A solar panel can be configured to provide electrical power for lighting the decorative structures.

### BACKGROUND

Solar energy is a clean, renewable, environmentally friendly source of energy that has been increasingly used in recent years. Embodiments of the present invention include a decorative product in which power for lighting the product can be provided from a solar energy source. Embodiments of the product can allow for easy interchange of decorative aspects of the product so that the look of the product can be easily changed as desired by a human user.

### SUMMARY

Some embodiments of the invention are directed to a solar powered decorative product, which can include a base having a plurality of connectors. A plurality of decorative structures can attach to and be detached from the connectors. A solar panel can be configured to provide electrical power for lighting the decorative structures.

### DESCRIPTION OF THE DRAWINGS

FIG. 1 shows an exemplary solar powered decorative product according to some embodiments of the invention.

FIG. 2 shows a top view of the base of the product of FIG. 1.

FIG. 3 shows a cross-sectional side view of the base of FIG. 2.

FIG. 4 shows an exemplary configuration of electrical elements that can be located in the base of FIGS. 2 and 3 according to some embodiments of the invention.

FIG. 5 shows another exemplary configuration of electrical elements that can be located in the base of FIGS. 2 and 3 according to some embodiments of the invention.

FIG. 6 shows a side, cross-sectional view of an exemplary configuration of an ornamental fixture of the product shown in FIG. 1 according to some embodiments of the invention.

FIG. 7 shows a top, cross-sectional view of the ornamental fixture of FIG. 6.

FIG. 8 shows the base of the product of FIG. 1 with other ornamental fixtures attached to the base according to some embodiments of the invention.

FIGS. 9-11 show the base of the product of FIG. 1 with still other ornamental fixtures attached to the base according to some embodiments of the invention.

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein.

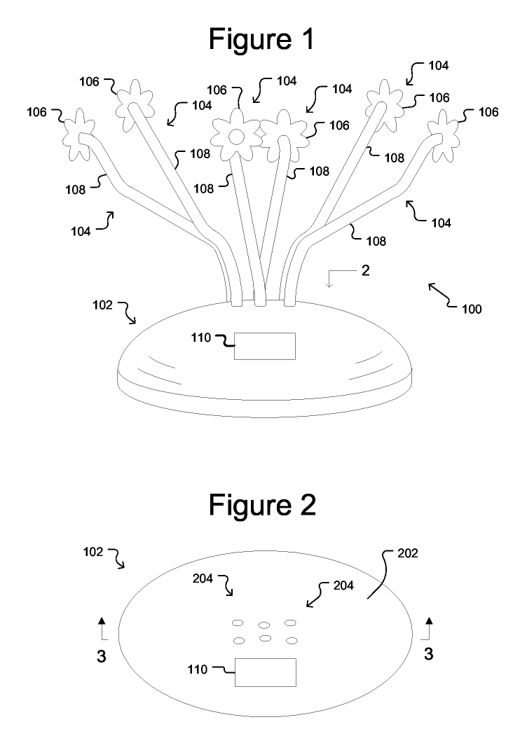

FIG. 1 illustrates an exemplary solar powered decorative product 100 according to some embodiments of the invention. As shown, the product 100 can comprise a base 102 and a plurality of ornamental fixtures 104. Each ornamental fixture 104 can comprise a decorative piece 106 and an extension peice 108, which can plug into the base 102. Each decorative piece 106 can comprise a light source (not shown in FIG. 1), and the base 102 can include a solar panel 110 configured to provide solar power to recharge batteries (not shown in FIG. 1) that provide power to the light source. As will be discussed, each ornamental fixture 104 can be bent, twisted, and/or arranged into any position. Consequently, a human user can arrange and position the ornamental fixtures 104 into any desired pattern or arrangement.

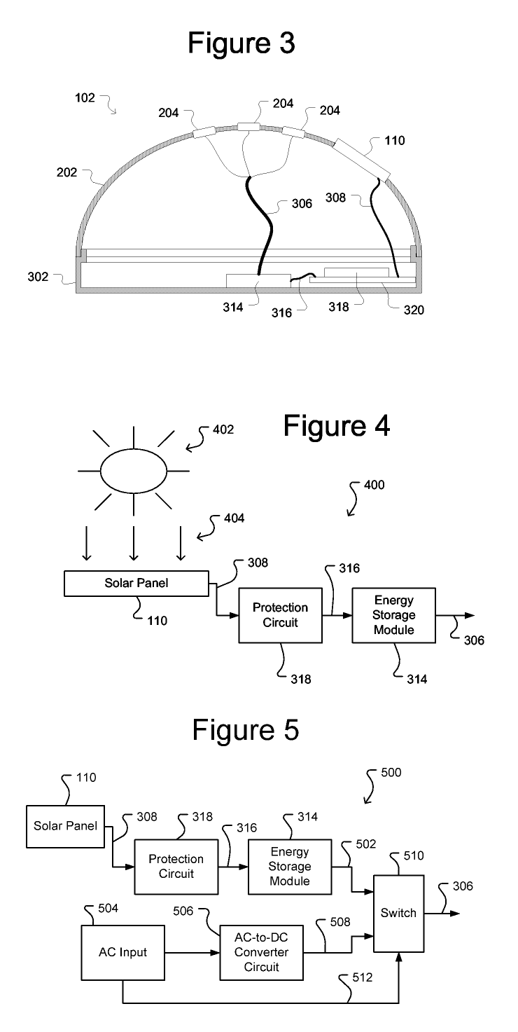

FIG. 2 shows a top view, and FIG. 3 shows a side, cross-sectional view of the base 102 according to some embodiments of the invention. As shown in FIGS. 2 and 3, the base 102 can include a top portion 202 that connects to (e.g., screws onto, fits onto, etc.) a bottom portion 302 to form a housing. The base 102 can be made of any suitable material, including without limitation polyresin, plastic, rubber, metal, wood, etc. The base 102 can be shaped and outer portions of the base 102 can be textured and/or colored to have a decorative appearance. For example, base 102 can be shaped, textured, and/or colored to have the appearance of a stone, a rock, a tree stump, a branch, a bush, a piece of wood, a planter, etc.

As shown in FIGS. 2 and 3, the base 102 can have a plurality of plugs 204, which can be configured to receive ornamental fixtures 104. An energy storage module 314, such as one or more batteries, can be located within the base 102 and can provide power through wires 306 to plugs 204. One or more wires 308 can electrically connect the solar panel 110 to one or more electric circuits, which can include a protection protection circuit 318. The protection protection circuit 318 as well as other circuits (not shown) can also be located within base 102. One or more wires 316 can electrically connect the protection circuit 318 to the energy storage module 314. The protection circuit 318, which can comprise one or more electric circuits integrated into a semiconductor “chip” or “chips,” can be attached to a wiring board 320 disposed within base 102 as shown in FIG. 3. Other circuits (e.g., other integrated circuit “chips”) and other circuit elements (e.g., capacitors, resistors, transistors, etc.) can also be attached to wiring board 320, which can include electrically conductive traces (not shown) and/or conductive vias (not shown) that electrically interconnect such other circuit elements and the protection circuit 318, wire or wires 308, and wire or wires 316.

FIG. 4 shows a simplified block diagram of the solar panel 110, protection circuit 318, and energy storage module 314 disposed in or on base 102 in FIG. 3. As shown in FIG. 4 and is known, as sun light 404 from the sun 402 strikes the solar panel 110, which can comprise a photovoltaic cell, the solar panel 110 can generate electricity in the form of a voltage, a current, or both a voltage and a current. The electricity generated by the solar panel 110 can be output through wire or wires 308 to the protection circuit 318, which can output through wire or wires 316 power in the form of electricity to the energy storage module 314 to charge the energy storage module 314.

Energy storage module 314 can comprise, for example, one or more batteries of any type that are rechargeable. For example, energy storage module 314 can comprise one or more deep cycle batteries (which are batteries that discharge a small current over a long period of time as opposed to shallow cycle batteries, which are configured to discharge large currents over a short period of time). Non-limiting examples of suitable batteries include nickel cadmium batteries or lead-acid batteries.

Protection circuit 318 can be configured to regulate the supply of power from the solar panel 110 to the energy storage module 314. For example, the protection protection circuit 318 can comprise circuitry, such as one or more diodes, that allows current to flow from the solar panel 110 to energy storage module 314 but prevents current from flowing in the reverse direction, that is, from the energy storage module 314 to the solar panel 110. Protection protection circuit 318 can also include charge controlling circuitry configured to disconnect the energy storage module 314 from the solar panel 110 while the energy storage module 314 is fully charged, which can prevent the energy storage module 314 from over charging and may prolong the working life of energy storage module 314. Thus, protection protection circuit 318 can be configured to determine whether energy storage module 314 is fully charged and connect power from solar panel 110 to the energy storage module 314 only while the energy storage module 314 is not fully charged. Protection circuit 316 can also monitor the power (e.g., electric charge) stored at the energy storage module 314 and cut power from energy storage module 314 to plugs 204 if the power stored in energy storage module 314 drops below a predetermined level. As is known, the operating life of many types of rechargeable batteries (as discussed above, energy storage module 314 can comprise rechargeable batteries) may be shortened if the power stored in the batteries becomes fully dissipated.

FIG. 5 shows a simplified block diagram of the solar panel 110, protection circuit 318, and energy storage module 314 disposed in or on base 102 in FIG. 3, and FIG. 5 also shows an alternating current (“AC”) input 504, an AC to direct current (“DC”) converter circuit 506, and switch 510 that can also be included in the base 102. As shown in FIG. 5, the solar panel 110, protection protection circuit 318, and energy storage module 314 can be configured as shown in FIG. 4 except that the output 502 of the energy storage module 314 is connected to a switch 510. As also shown in FIG. 5, the AC input 504, which can be configured to receive input from a source of AC electrical power, can provide AC electrical power to the AC-to-DC converter circuit 506, which converts the AC electrical power to DC electrical power. The DC electrical power can be output 508 from the AC-to-DC converter circuit 506 to switch 510. A signal 512 can be provided from the AC Input 504 to the switch 510. The signal 512 can indicate the presence or absence of an AC power source (not shown) at AC input 504. That is, while a source of AC power (not shown) is connected to AC input 504, signal 512 can be in a first state, and while a source of AC power (not shown) is not connected to AC input 504, signal 512 can be in a second state. While signal 512 is in the first state-indicating that a source of AC power (not shown) is connected to AC input 504-switch 510 can pass power from the output 508 of the AC-to-DC converter circuit to the wires 306 that provide power to plugs 204 (see FIG. 3). On the other hand, while signal 512 is in the second state—indicating that a source of AC power (not shown) is not connected to AC input 504—switch 510 can pass power from the output 502 of the energy storage module 502 to the wires 306 that provide power to plugs 204 (see FIG. 3).

Many variations of and additions to the configurations of the circuit elements shown in FIG. 5 are possible. For example, although not shown in FIG. 5, provisions can be made to alternatively charge energy storage module 314 with power from the AC power source (not shown) connected to AC input 504. For example, the configuration shown in FIG. 5 can be configured such that the energy storage module 314 is charged with power produced by the solar panel 110 while the solar panel 110 produces sufficient power to charge the energy storage module 314, but while the solar panel 110 is not producing power (e.g., while sun light is not striking the solar panel 110, such as at night), power from an AC power source (not shown) connected to the AC input 504 charges the energy storage module 314.

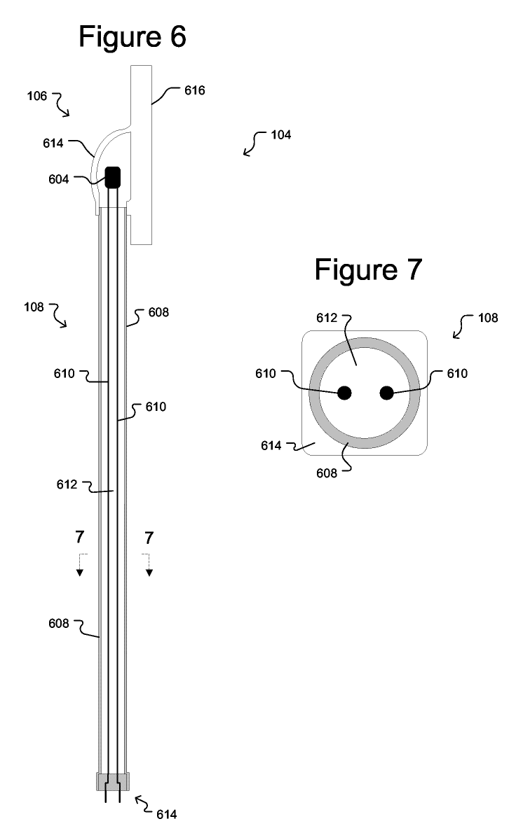

FIG. 6 shows a side, cross-sectional view of one of the ornamental fixtures 104 of FIG. 1, and FIG. 7 shows a top, cross-sectional view of the extension portion 108 of the ornamental fixture. As shown in FIGS. 6 and 7, the extension portion 108 can include electrically conductive wires 610 for providing electrical power from a plug 614 to a light source 604, which can be, for example, a light emitting diode. The plug 614 can connect to (e.g., “plug” into) one of the plugs 204 in base 102 and can thus receive electrical power from the energy storage module 314 through ones of wires 306. (See FIGS. 2 and 3.) Plugs 204 in base 102 and plugs 614 that are part of the ornamental fixtures 104 can be configured to fit together such that the ornamental fixtures 104 can be mechanically attached to the base 102 and can be detached from the base 102. In addition, plugs 204 and plugs 614 can be configured such that, while fitted together, plugs 204 and plugs 614 form electrical connections, electrically connecting wires 306 in base 102 to wires 610 in extension piece 108. Many such plugs 204 and plugs 614 are known, and any such plugs can be used.

Still referring to FIGS. 5 and 7, the wires 610 can be embedded in a flexible casing 612, which can be semi-solid yet flexible. The casing 612 can be made of a plastic material that allows the extension piece 108 to be bent and/or twisted into any position desired by a human user. The plastic material can be sufficiently flexible to allow for such bending and twisting, and the wires 610, which can be metallic wires (e.g., copper wires) can provide sufficient shape memory that the extension piece 108 remains in the bent and/or twisted position until a human user bends or twists the extension piece 104 into a new position. (FIG. 1 shows ornamental fixtures 104 bent into a variety of positions.) Alternatively, additives (not shown) can be added to the casing 612 to provide the shape memory necessary for the extension piece 108 remains in the bent and/or twisted position until a human user bends or twists the extension piece 108 into a new position. For example, metal can be embedded in casing 612 to provide such shape memory. In such a case, the wires 610 can be have an outer covering (not shown) made of an electrically insulating material. Such a covering (not shown) can electrically insulate the wires 610 from the metal (not shown) in the casing 612 so that the metal in the casing 612 does not short the wires 610. The metal (not shown) in the casing 612 can be, for example, in the form of a metallic sheath embedded in the casing 612 that surrounds the wires 610 (but does not make electrical connections with the wires 610).

As shown in FIG. 6, the decorative piece 106 can comprise a housing 614 and an artful portion 616. The housing 614 can provide a space for the light 604, which can be located so as to illuminate the artful portion 616. The housing 614 and the artful portion 616 can be formed of a transparent or semi-transparent material, which can be colored. For example, the housing 614 and the artful portion 616 can be made of plastic (colored or not colored), rubber, etc. While the light source 604 is illuminated, the light source 604 can provide light to illuminate the artful portion 616. The artful portion 616 can be located adjacent the housing 614 as shown in FIG. 6. Alternatively, the artful portion 616 can surround the housing 614. The housing 614 and the artful portion 616 can be integrally formed such that the housing 614 and the artful portion 616 form a signal structure. Alternatively, the housing 614 and the artful portion 616 can be separate structures that are joined to each other.

As shown in FIG. 6, housing 614 can attach to the extension piece 108. The housing 614 or the housing 614 in combination with the artful portion 616 can be sufficiently sealed to protect the light source 604 from water, dirt, dust, and other potentially harmful elements in the surroundings. As also shown in FIGS. 6 and 7, a protective cover 608 made of, for example, clear or colored plastic, rubber, etc., can be provided over the extension piece 108 to protect the extension piece 108 and the wires 610 from water, dirt, dust, and other potentially harmful elements in the surroundings. The ornamental fixture 104 can thus be weather proofed. The base 102 and the plugs 204 (see FIGS. 2 and 3) and the plug portion 614 of the ornamental fixture can similarly be weather proofed so that the product 100 (see FIG. 1) can be used in outdoor environments. For example, the product 100 can be placed in a garden or on a patio, porch, balcony, walk way, etc.

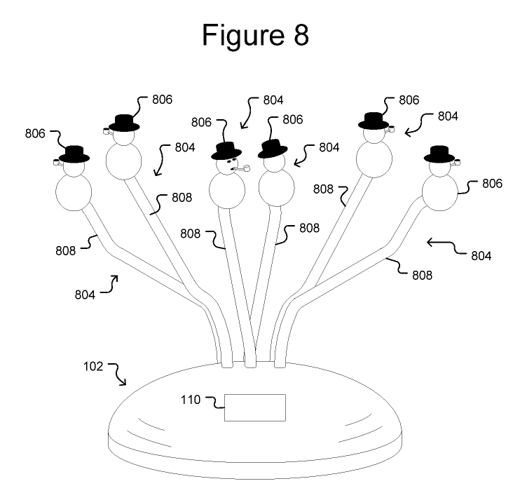

The artful portion 616 of the decorative piece 106 can be any artful or decorative design. For example, the artful portion 616 of the decorative pieces 106 shown in FIG. 1 are in the form of flowers. As mentioned above, the light source 604 can illuminate the artful portion 616 such that the artful portion 616 is lighted and glows. The design of the artful portion 616 can be themed for particular times of the year. For example, the flower design of the decorative piece 106 shown in FIG. 6 can be used during the spring portion of the year. During other portions of the year, the flowered ornamental fixtures 104 shown in FIG. 1 can be unplugged from base 102 and other ornamental fixtures with different decorative pieces can be plugged into base 102. FIG. 8 shows an example in which ornamental fixtures 104 of FIG. 1 have been unplugged from base 102 and replaced with ornamental fixtures 804. As shown, each ornamental fixture 804 can include an extension piece 808 and a decorative piece 806. Extension piece 808 can be generally the same as or similar to extension piece 108, and decorative piece 806 can be structurally the same as or similar to decorative piece 106. The decorative design of piece 806, however, can be different. For example, the decorative design of piece 806 in FIG. 8 is a snow person, which can be a theme used during winter time of the year. Thus, the primary difference between the ornamental fixtures 804 of FIG. 8 and the ornamental fixtures 104 of FIG. 1 can be the design of the decorative piece 806. Many ornamental fixtures (e.g., like 104, 804) can be made with many different decorative designs. The ornamental fixtures (e.g., 104, 804) can be removed from base 102 and replaced with similar ornamental fixtures but different decorative designs (e.g., of decorative pieces 106, 806) at various times throughout the year. The decorative designs can thus be changed to suit changes in the seasons or holidays throughout the year or simply to suit decorative changes desired by a human user.

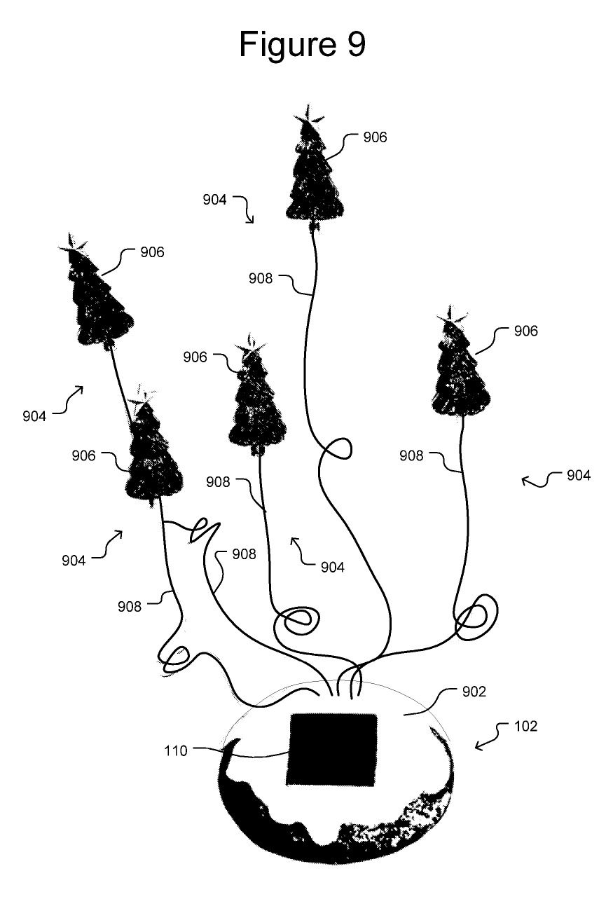

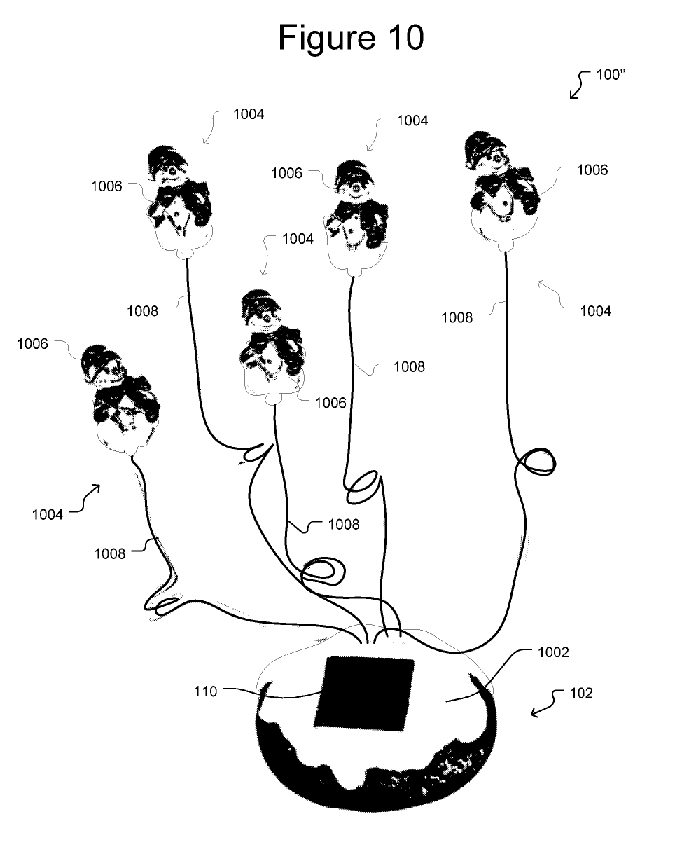

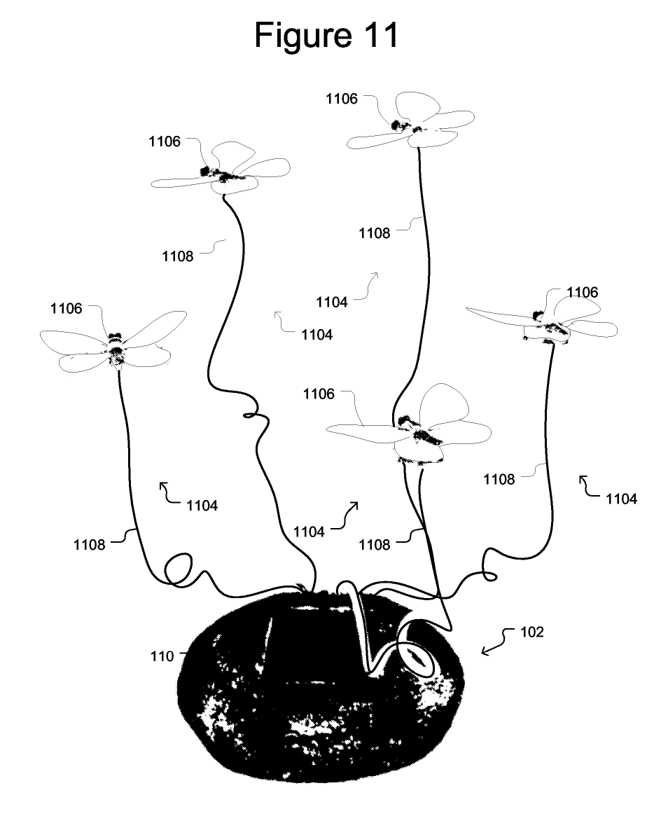

FIGS. 9-11 illustrate base 102 (with solar panel 110) into which different ornamental fixtures 904 in FIG. 9, ornamental fixtures 1004 in FIG. 10, and ornamental fixtures 1104 in FIG. 11 are plugged. The ornamental fixtures 904, 1004, 1104 can include plugs (not shown in FIG. 9) like plug 614 of FIG. 6 that plug into plugs 204 (see FIGS. 2 and 3) of the base 102. Each ornamental fixture 904, 1004, 1104 can include an extension piece 908, 1008, 1108, which can be the same as or similar to extension piece 608 shown in FIG. 6, and a decorative piece 906, 1006, 1106, which can be structurally the same as or similar to the decorative piece 906 shown in FIG. 6. As shown in FIG. 9, however, the design of decorative piece 906 in FIG. 9 is a Christmas tree, the design of decorative piece 1006 in FIG. 10 is a snow person, and the design of decorative piece 1106 in FIG. 11 is a butterfly. As shown in FIGS. 9 and 10, decorative features can be placed on or attached to the base 102. For example, a decorative feature 902, 1002 having the appearance of snow is shown on base 102 in FIGS. 9 and 10.

Although specific embodiments and applications of the invention have been described in this specification, there is no intention that the invention be limited these exemplary embodiments and applications or to the manner in which the exemplary embodiments and applications operate or are described herein. For example, although the change from flowers in FIG. 1 to snow persons in FIG. 8 is described above as being accomplished by detaching the ornamental fixtures 104 in FIG. 1 from base 102 and then attaching the ornamental fixtures 804 of FIG. 8 to base 102, the change from flowers to snow persons can alternatively be made by removing decorative pieces 106 (flowers) from extension pieces 108 in FIG. 1 and then attaching decorative pieces 804 (snow persons) to the extension pieces 108 without ever needing to remove extension pieces 108 from the base 102.

What is claimed is:

1. A solar powered decorative product comprising:
a base comprising a plurality of connectors;
a plurality of decorative structures, wherein each decorative structure can be attached to and detached from one of the connectors of the base; and
a solar panel configured to provide electrical power for lighting the decorative structures.

2. The product of claim 1, wherein each of the decorative structures comprises:
a plug configured to connect the decorative structure to one of the connectors of the base,
a decorative piece,
a light source disposed to illuminate the decorative piece, and
a wiring extension piece comprising electrically conductive wires extending from the plug to the light source.

3. The product of claim 2, wherein the wiring extension piece is elongate and sufficiently flexible to be bent or twisted by a human user.

4. The product of claim 3, wherein the wiring extension piece has sufficiently shape memory to remain in a first bent or twisted position until bent or twisted into a new position.

5. The product of claim 2, wherein the light source comprises a light emitting diode.

6. The product of claim 2, wherein each of the decorative structures and the base comprise weather proofing materials.

7. The product of claim 2 further comprising a power storage module, wherein the solar panel is electrically connected to the power storage module and is configured to provide electrical power to charge the power storage module.

8. The product of claim 7, wherein the power storage module is electrically connected to the connectors of the base, wherein while the decorative structures are connected to the connectors, the power storage module is electrically connected to the light sources of the decorative structures.

9. The product of claim 8, wherein the power storage module comprises at least one rechargeable battery.

10. The product of claim 8, wherein the solar panel is disposed on a housing of the base.

11. A method of using a solar powered decorative product, the decorative product comprising:
a base comprising a plurality of connectors,
a plurality of decorative structures each comprising a plug configured to connect the decorative structure to one of the connectors of the base, a decorative piece, a light source disposed to illuminate the decorative piece, and a wiring extension piece comprising electrically conductive wires extending from the plug to the light source, and
a solar panel configured to provide electrical power for lighting the decorative structures,
the method comprising:
plugging first ones of the decorative structures into ones of the connectors of the base, the first ones of the decorative structures having a first decorative design;
operating the product with the first ones of the decorative structures plugged into the ones of the connectors of the base for a time period;
removing the first ones of the decorative structures from the base; and
plugging second ones of the decorative structures into the ones of the connectors of the base, the second ones of the decorative structures having a second decorative design that is different than the first decorative design.

12. The method of claim 11, wherein the operating comprises lighting the light sources in the first ones of the decorative structures with power produced by the solar panel.

13. The method of claim 12, wherein the first decorative design corresponds to a first yearly seasonal theme, and the second decorative design corresponds to a second yearly seasonal them that is different than the first yearly seasonal theme.

14. The method of claim 12 further comprising bending or twisting ones of the second decorative structures into first positions, wherein the second decorative structures are arranged in a first decorative pattern.

15. The method of claim 14 further comprising bending or twisting ones of the second decorative structures into second positions, wherein the second decorative structures are arranged in a second decorative pattern different than the first decorative pattern.

16. The method of claim 111 further comprising bending or twisting ones of the first decorative structures into first positions, wherein the first decorative structures are arranged in a first decorative pattern.

17. The method of claim 14 further comprising bending or twisting ones of the first decorative structures into second positions, wherein the first decorative structures are arranged in a second decorative pattern different than the first decorative pattern.
